(19) United States
(12) Patent Application Publication
(10) Pub. No.: US 2026/0084270 A1
(43) Pub. Date: Mar. 26, 2026

(54) RATCHET WRENCH ASSEMBLY STRUCTURE

(71) Applicant: YIH CHENG FACTORY CO., LTD., Nantuo (TW)

(72) Inventor: Jack LIN, Nantuo (TW)

(21) Appl. No.: 18/892,342

(22) Filed: Sep. 21, 2024

(51) Int. Cl. B25B 13/46

(52) U.S. Cl. CPC B25B 13/463

(57) ABSTRACT

A ratchet wrench includes a wrench set, a ratchet set, a retaining ring, and a control set. The wrench set includes a working end and a fixing end. A tool hole is defined on the working end. The flange and the groove are disposed spacedly on the fixing end. The ratchet set includes a ratchet base, a ratchet component, and a latch member. The ratchet base is disposed on the flange. The retaining ring is fastened in the groove and presses against the ratchet base. The control set is movably disposed on the ratchet base and includes an operation key. The operation key makes the latch member be engaged with the ratchet component.

### BACKGROUND OF THE DISCLOSURE

### Technical Field

The technical field relates to a hand tool, and particularly to a ratchet wrench assembly structure.

### Description of Related Art

A ratchet wrench is a common hand tool widely used in mechanical maintenance and assembly work. The main purpose of the ratchet wrench is to tighten or loosen bolts and nuts, and continuous rotation in one direction is achieved through a ratchet mechanism for fast and efficient operation.

Furthermore, a ratchet component is provided on the existing ratchet wrench. The assembly of the ratchet component is secured by a retaining ring engaged between the annular groove of the wrench and the recessed groove of the ratchet component. Additionally, a protruding portion is provided on the bottom side of the wrench to support the ratchet component and prevent the ratchet component from detaching from the wrench. However, the processing steps of the aforementioned ratchet wrench are relatively complicated, which results in inconvenience during assembly.

In view of the above drawbacks, the inventor proposes this disclosure based on his expert knowledge and elaborate researches in order to solve the problems of related art

### SUMMARY OF THE DISCLOSURE

This disclosure provides a ratchet wrench assembly structure to simplify the assembly process and method, and increase the convenience of assembly.

This disclosure is a ratchet wrench assembly structure includes a wrench set, a ratchet set, a retaining ring, and a retaining ring. The wrench set includes a rod body. The rod body includes a working end and a fixing end. A tool hole is defined on the working end. A flange and a groove are disposed spacedly on the fixing end. The ratchet set includes a ratchet base, a ratchet component, and a latch member. The ratchet base is disposed on the flange, and the ratchet component is arranged with the latch member in the ratchet base. The retaining ring is fastened in the groove and presses against the ratchet base. The ratchet base is clamped by the retaining ring (30) to be positioned on the fixing end. The control set is movably disposed on the ratchet base. The control set includes an operation key, and a pin and a spring assembled in the operation key. The pin is combined with the spring to elastically abut against the latch member to make the latch member be engaged with the ratchet component.

In one embodiment of this disclosure, the ratchet wrench assembly structure further includes a T-handle combined with the rod body, and the ratchet set is accommodated in the T-handle.

In one embodiment of this disclosure, the ratchet wrench assembly structure further includes a C-ring fastened on one end of the T-handle. A notch is defined on the rod body and is located between the working end and the fixing end, and the T-handle is fixed on the rod body through the C-ring embedded in the notch.

In one embodiment of this disclosure, the ratchet wrench assembly structure further includes a cover plate combined with the T-handle. A sliding groove is defined on the T-handle, and an opening is defined between the cover plate and the T-handle. The sliding groove is exposed from the cover plate, and one end of the operation key protrudes from the opening and is exposed on the sliding groove.

In one embodiment of this disclosure, the T-handle includes an accommodating space, and the accommodating space includes a first cavity and a second cavity communicating with each other. A bottom plate is disposed in the first cavity, the ratchet base is accommodated in the first cavity, the sliding groove is located in the second cavity, and the cover plate is accommodated in the second cavity.

In one embodiment of this disclosure, a hole is defined on the ratchet set. The operation key includes a key part and a lever part. The key part extends into the hole to abut against the ratchet component, and the lever part rotates left and right along the sliding groove under an external force.

In one embodiment of this disclosure, a receiving hole is defined on the key part, and the spring is adapted to sheathe the pin and inserted in the receiving hole.

In one embodiment of this disclosure, the pin includes a head and a shaft; the spring is adapted to sheathe the shaft. One end of the spring abuts against the head, and the other end of the spring presses against a wall of the receiving hole.

In one embodiment of this disclosure, a plurality of first teeth is disposed equidistantly on an outer periphery of the ratchet component. The latch member includes a plurality of second teeth arranged continuously on a side facing the ratchet component. The latch member is pushed by the pinto make the second teeth be engaged with the first teeth.

In one embodiment of this disclosure, the ratchet wrench assembly structure further includes a sleeve with a plurality of anti-slip ribs, and the sleeve is adapted to sheathe the working end.

In comparison with the related art, the rod body of the wrench set of the ratchet wrench assembly structure is provided with a flange and a groove. The ratchet set is disposed on the flange, and the ratchet base is clamped by the retaining ring engaged in the groove. Accordingly, the ratchet set is positioned on the wrench set, which eliminates the need for machining processes such as disposing grooves and flanges on the inner edge of the ratchet component to simplify the assembly process and method, thereby enhancing the convenience of assembly.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 depicts a perspective schematic view of the ratchet wrench assembly structure according to this disclosure.

FIG. 2 and FIG. 3 depict perspective exploded schematic views of the ratchet wrench assembly structure from two sides according to this disclosure.

FIG. 4 and FIG. 5 depict perspective exploded views of the ratchet set and the control set from two sides according to this disclosure.

FIG. 6 depicts a cross-sectional view of the ratchet wrench assembly according to this disclosure.

FIG. 7 and FIG. 8 depict partially enlarged schematic views of the ratchet wrench assembly structure from two sides according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

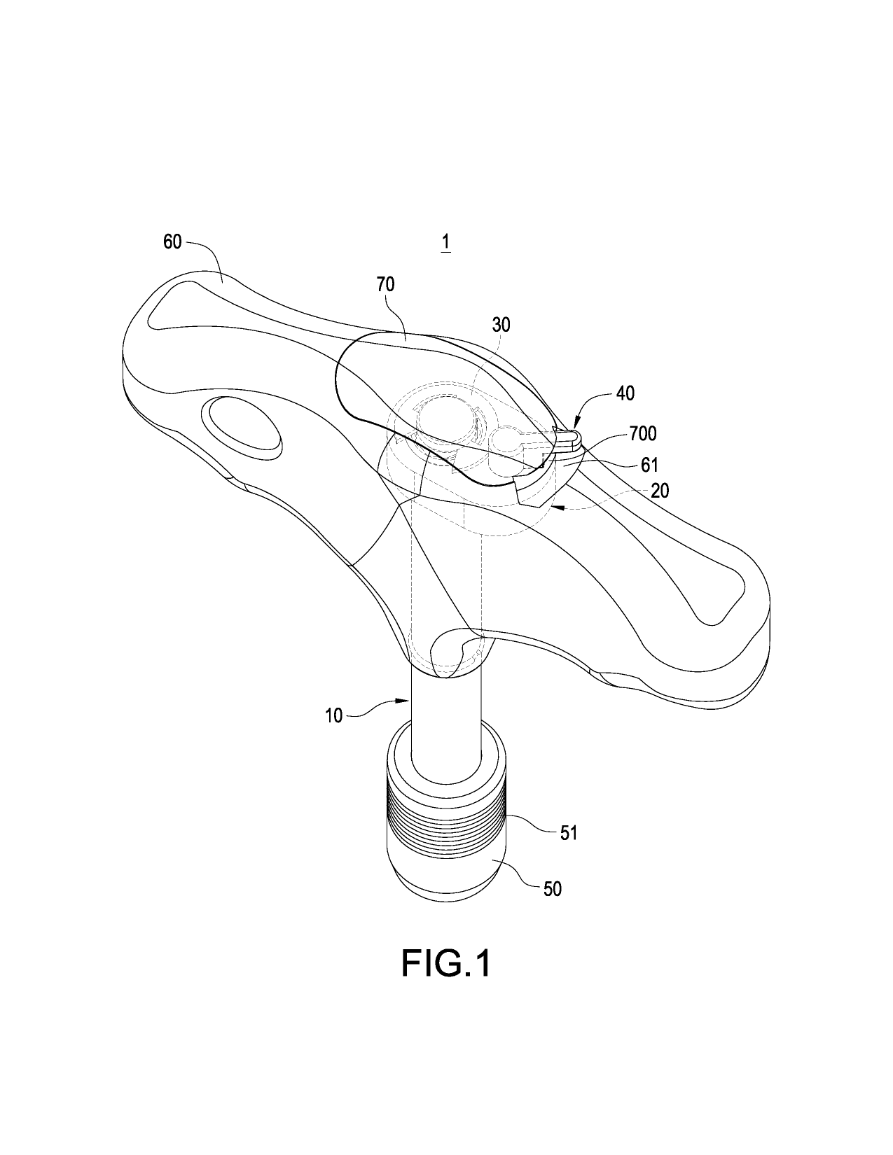

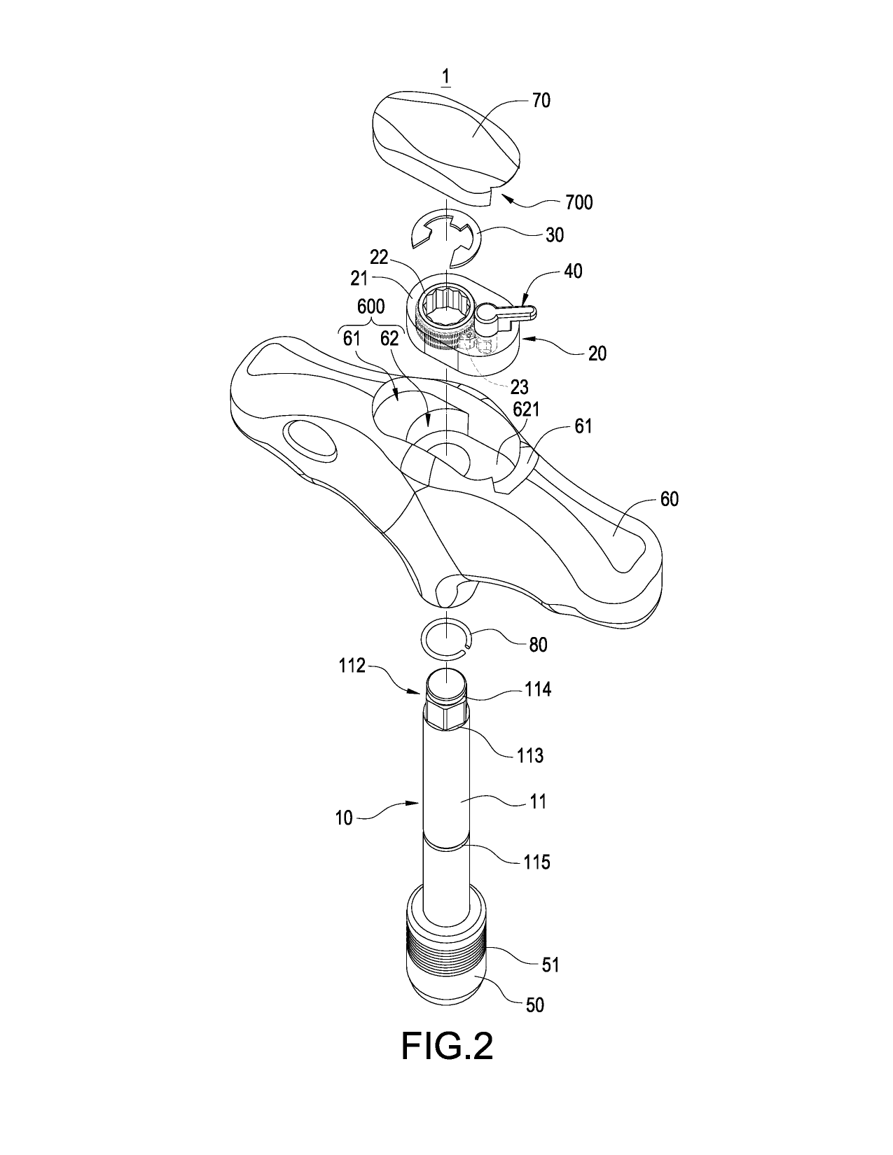

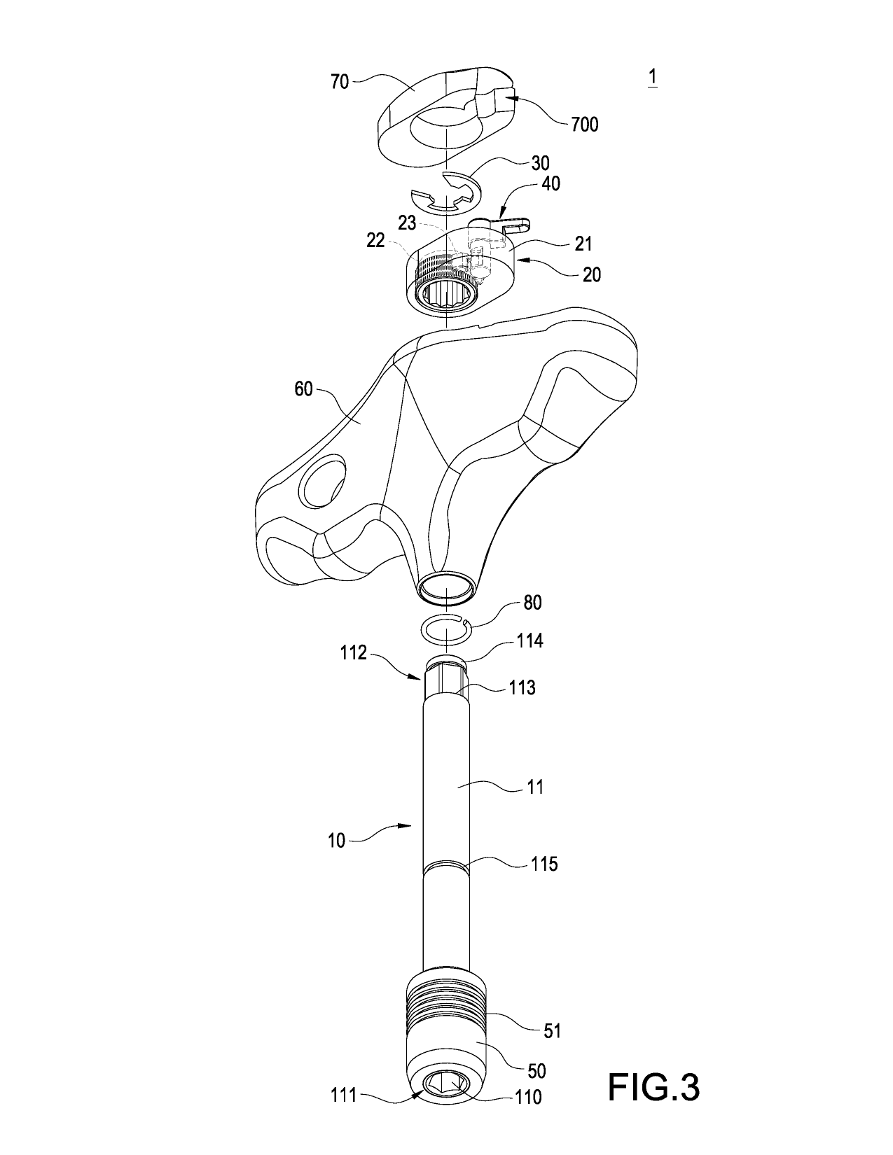

Please refer to FIG. 1 to FIG. 3, which depict a perspective schematic view of the ratchet wrench assembly structure according to this disclosure and two perspective exploded schematic views of the ratchet wrench assembly structure from two sides according to this disclosure. The ratchet wrench assembly structure 1 includes a wrench set 10, a ratchet set 20, a retaining ring 30, and a control set 40. The ratchet set 20 is positioned on the wrench set 10 through the retaining ring 30. Additionally, the control set 40 is disposed on the ratchet set 20. The control set 40 moves under an external force and presses against the ratchet set 20. Accordingly, the wrench set 10 rotates in a predetermined direction to perform tightening and loosening operations on nuts or bolts. A more detailed description of the ratchet wrench assembly structure 1 is as follows.

The wrench set 10 includes a rod body 11. The rod body 11 has a working end 111 and a fixing end 112. A tool hole 110 is defined on the working end 111. A flange 113 and a groove 114 are spaced apart on the fixing end 112.

The ratchet set 20 includes a ratchet base 21, a ratchet component 22, and a latch member 23. The ratchet base 21 is placed on the flange 113 of the wrench set 10, and the ratchet component 22 is arranged with the latch member 23 in the ratchet base 21.

Moreover, the retaining ring 30 is fastened in the groove 114 and presses against the ratchet base 21. The ratchet base 21 is clamped by the retaining ring 30 to be positioned on the fixing end 112. Additionally, the control set 40 is movably disposed on the ratchet base 21 to operate the ratchet set 20 for rotating in a predetermined direction.

In this embodiment, the ratchet wrench assembly structure 1 further includes a sleeve 50. The sleeve 50 is provided with a plurality of anti-slip ribs 51 and is placed outside (sheathes) the working end 111. The arrangement of the sleeve 50 allows the user to grip and move it to a working position.

Furthermore, the ratchet wrench assembly structure 1 further includes a T-handle 60 and a cover plate 70 combined with the T-handle 60. The T-handle 60 is attached to the rod body 11, and the ratchet set 20 is accommodated in the T-handle 60. Additionally, a sliding groove 61 is defined on the T-handle 60. An opening 700 is defined between the cover plate 70 and the T-handle 60, and the sliding groove 61 is exposed from the cover plate 70.

The ratchet wrench assembly structure 1 further includes a C-ring (fixing ring) 80 fastened at one end of the T-handle 60. A notch 115 is defined on the rod body 11 and is located between the working end 111 and the fixing end 112. The T-handle 60 is fixed on the rod body 11 through the C-ring 80 being embedded in the notch 115.

Specifically, the T-handle 60 has an accommodating space 600. The accommodating space 600 includes a first cavity 601 and a second cavity 602 communicating with each other. A bottom plate 621 is located in the first cavity 601, and the ratchet base 21 is accommodated in the first cavity 601. The sliding groove 61 is disposed in the second cavity 602, and the cover plate 70 is accommodated in the second cavity 602.

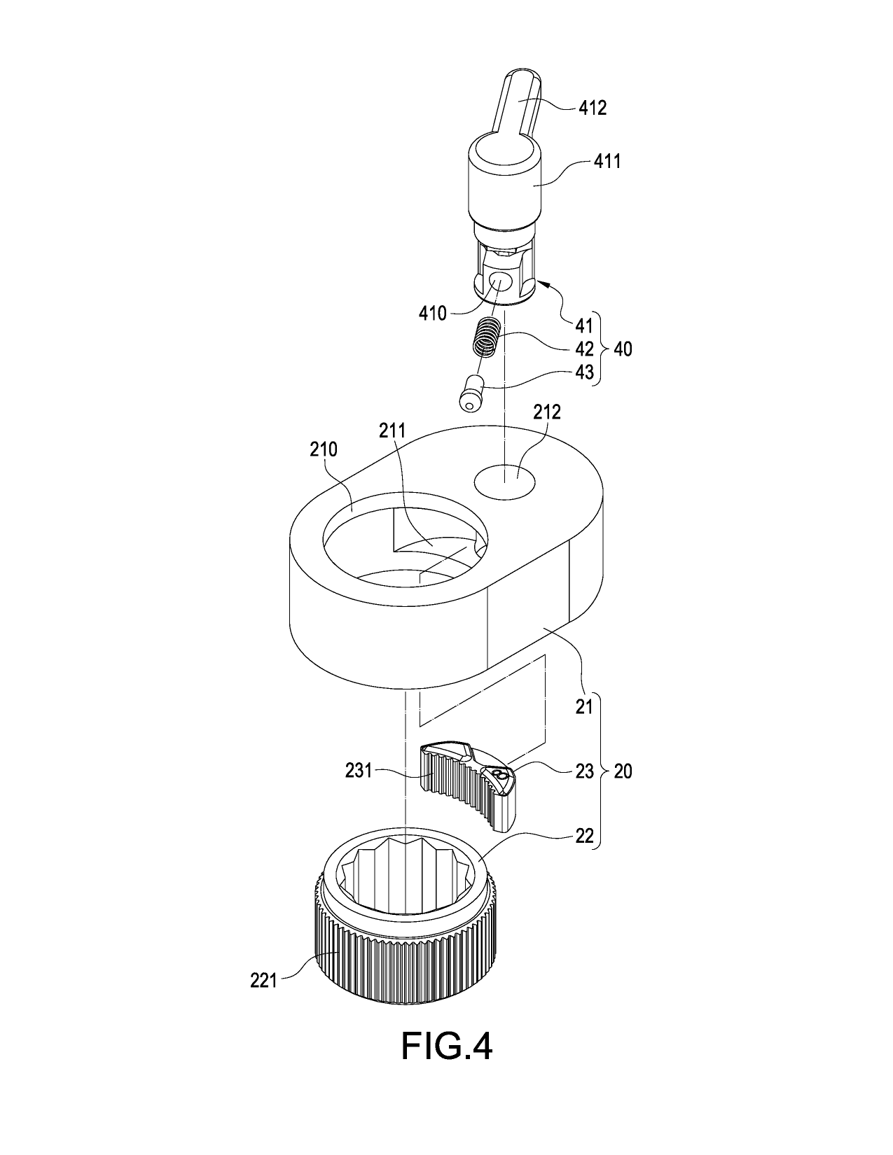

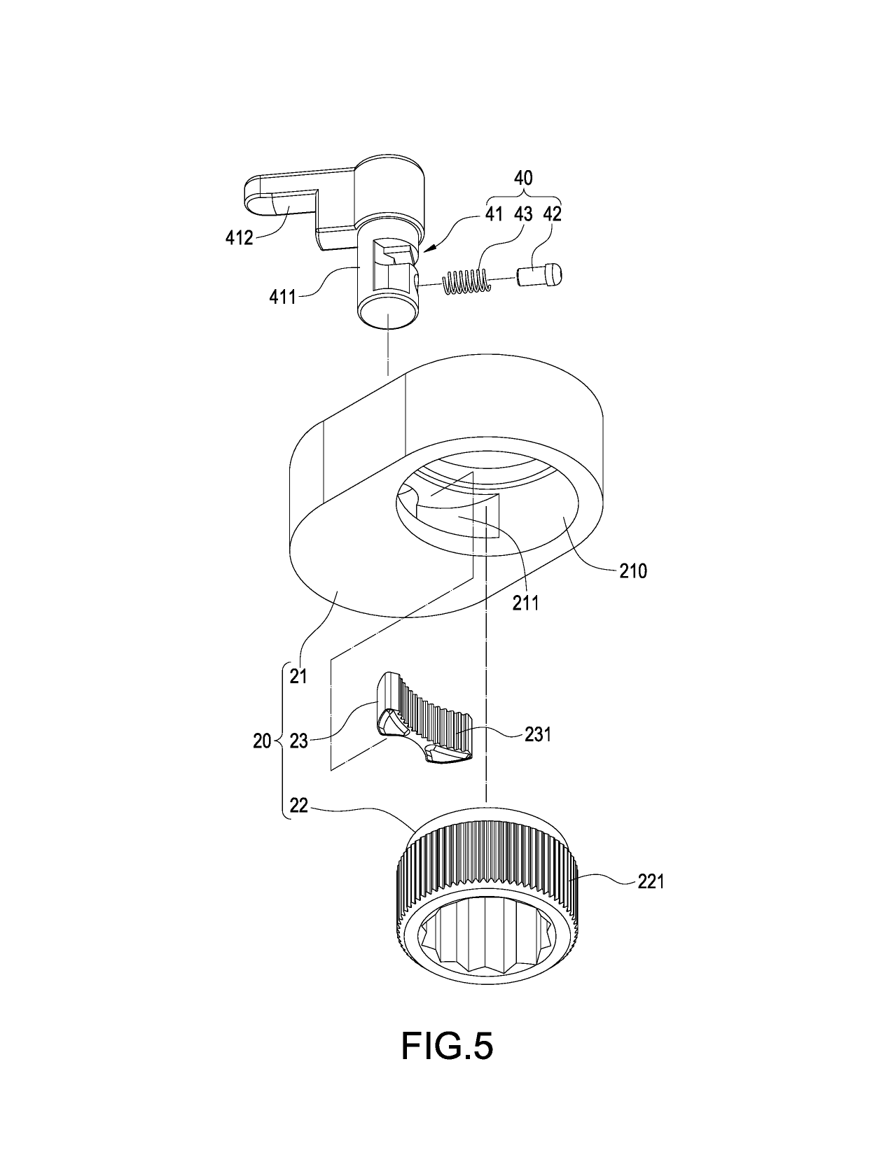

Please further refer to FIG. 4 and FIG. 5, which depict perspective exploded views of the ratchet set and the control set from two sides according to this disclosure. The ratchet set 20 includes a ratchet base 21, a ratchet component 22, and a latch member 23. A through hole 210 and a slot 211 communicating with the through hole 210 are defined on the ratchet base 21. The ratchet base 21 is placed in the through hole 210. The latch member 23 is disposed in the slot 211 and is located on one side of the ratchet component 22. Additionally, a plurality of first teeth 221 are arranged equidistantly on the outer periphery of the ratchet component 22. The latch member 23 includes a plurality of second teeth 231 arranged continuously on the side facing the ratchet component 22.

Moreover, the control set 40 includes an operation key 41, a pin 42, and a spring 43 assembled in the operation key 41. The pin 42 is combined with the spring 43 to elastically press against the latch member 23 to make the latch member 23 be engaged with the ratchet component 22.

Specifically, a hole 212 is defined on the ratchet set 21. Moreover, the operation key 41 includes a key part 411 and a lever part 412. The key part 411 extends into the hole 212 to abut against the ratchet component 22. A receiving hole 410 is defined on the key part 411. The spring 43 is adapted to sheathe the pin 42 and is inserted in the receiving hole 410.

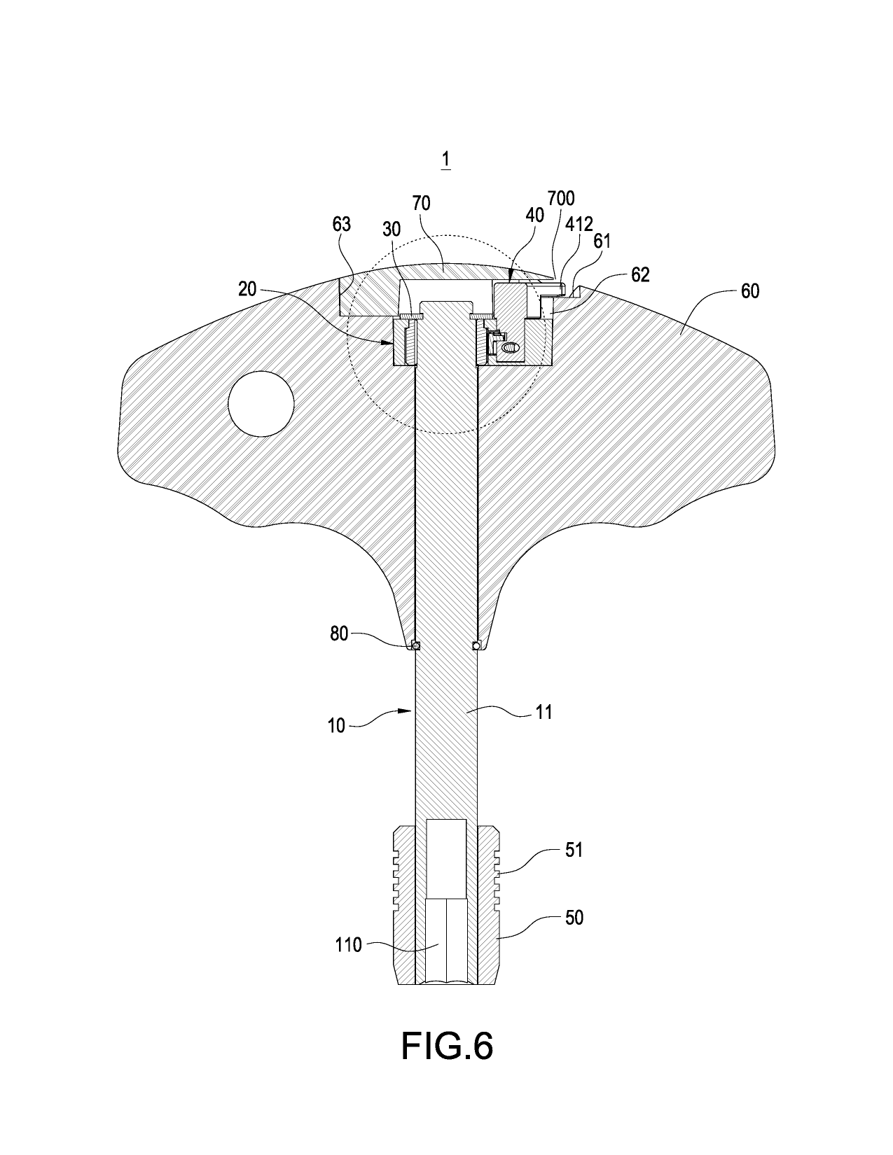

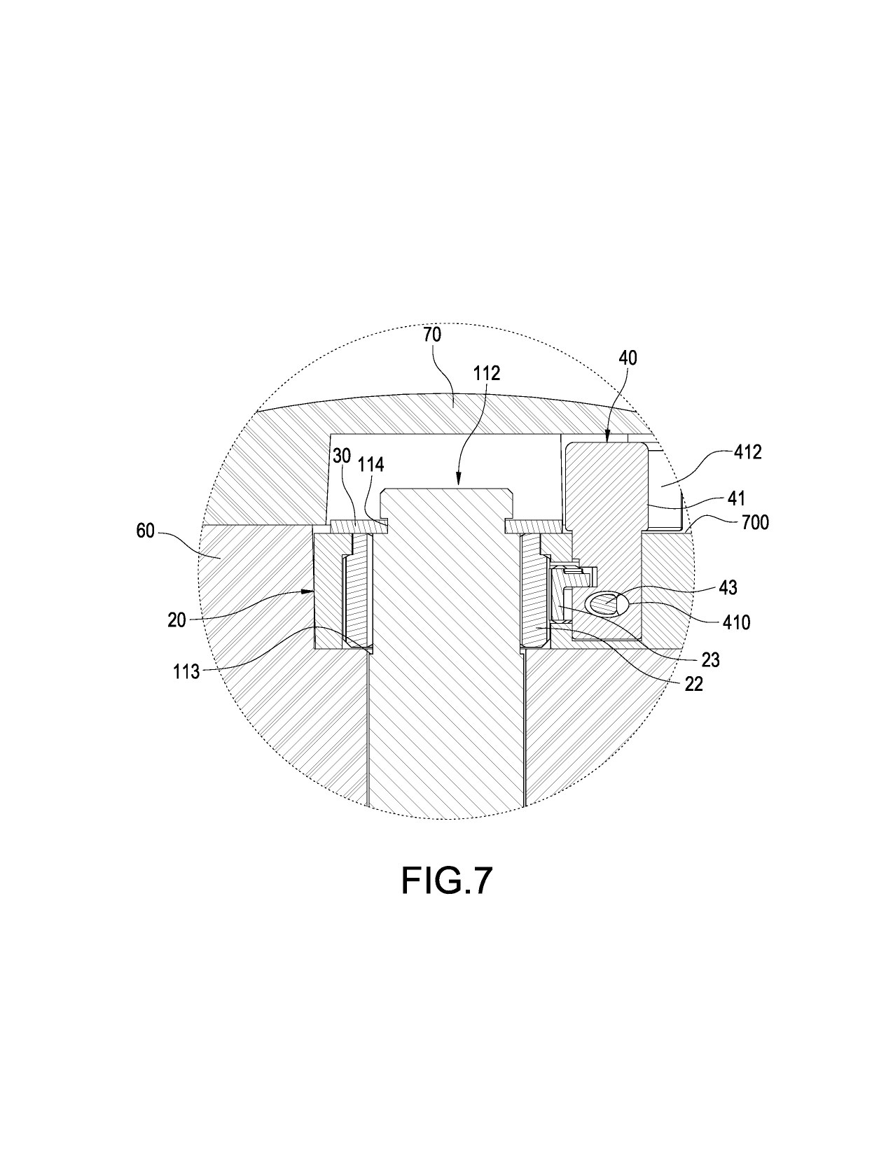

Please further refer to FIG. 6 to FIG. 8, which depict a cross-sectional view of the ratchet wrench assembly according to this disclosure and two partially enlarged schematic views of the ratchet wrench assembly structure from two sides according to this disclosure. The ratchet wrench assembly structure 1 includes a wrench set 10, a ratchet set 20, a retaining ring 30, a control set 40, and a T-handle 60. The flange 113 and the groove 114 are disposed on the fixed end 112 of the rod body 11 of the wrench set 10. The ratchet set 20 is disposed on the flange 113. The retaining ring 30 is fastened in the groove 114 and presses against the ratchet base 21, thereby positioning the ratchet set 20 on the wrench set 10. Additionally, the tool hole 110 is defined on the working end 111 of the rod body 11 to sheathe and rotate bolts or nuts.

The control set 40 includes an operation key 41, a pin 42, and a spring 43. One end of the operation key 41 protrudes from the hole 212 and is exposed in the sliding groove 61. It should be noted that the operation key 41 includes a lever part 412. The lever part 412 rotates left and right along the sliding groove 61 of the T-handle 60 under an external force. Additionally, the pin 42 includes a head 421 and a shaft 422. The spring 43 is placed over (sheathes) the shaft 422. One end of the spring 43 abuts against the head 421, and the other end of the spring 43 presses against the wall of the receiving hole 410.

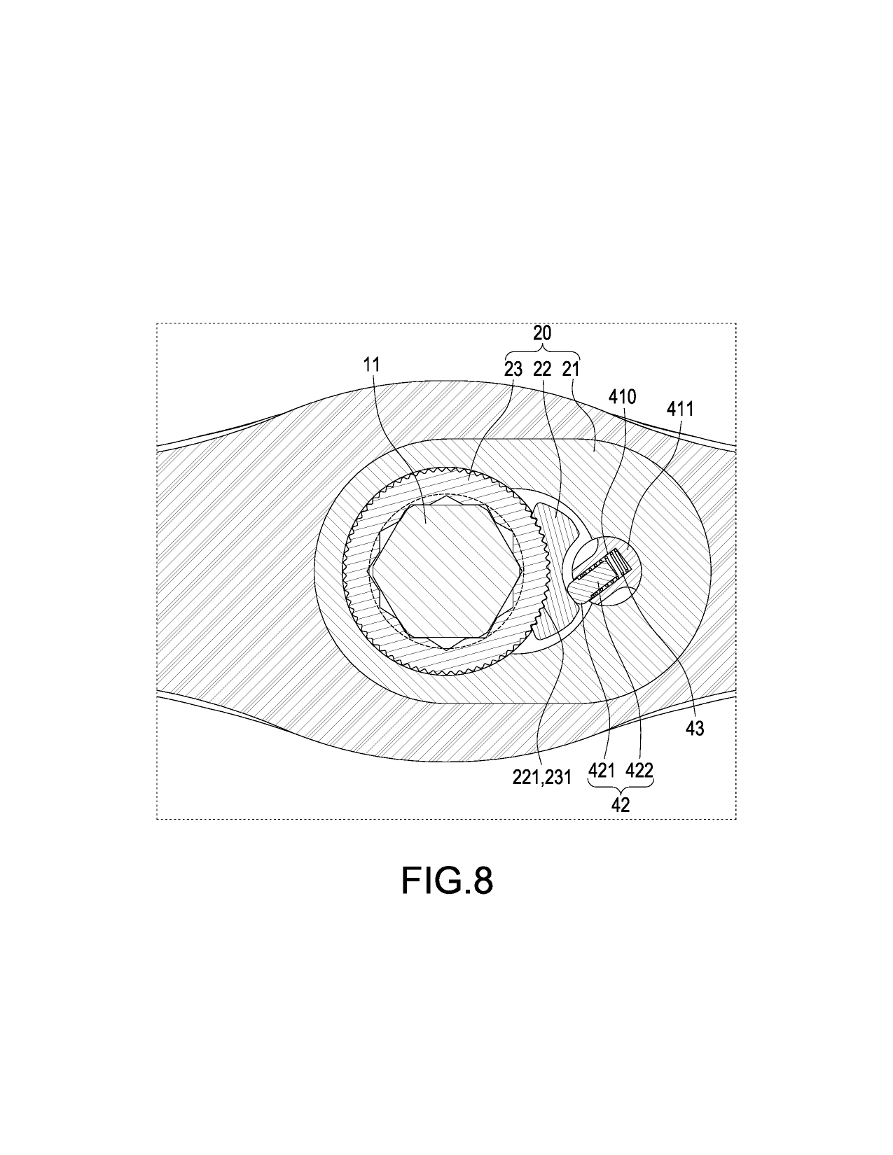

As shown in FIG. 8, the ratchet component 22 includes multiple first teeth 221 disposed equidistantly on the outer periphery thereof, and the latch member 23 includes multiple second teeth 231 are arranged continuously on the side facing the ratchet component 22. The latch member 23 is pushed by the pin 4 to make the second teeth 231 be engaged with the first teeth 221. Thus, the ratchet wrench assembly structure 1 may perform tightening and loosening operations on nuts or bolts.

While this disclosure has been described by means of specific embodiments, numerous modifications and variations may be made thereto by those skilled in the art without departing from the scope and spirit of this disclosure set forth in the claims.

What is claimed is:

1. A ratchet wrench assembly structure, comprising:
a wrench set, comprising a rod body, the rod body comprising a working end and a fixing end, wherein a tool hole is defined on the working end, and a flange and a groove are disposed spacedly on the fixing end;
a ratchet set, comprising a ratchet base, a ratchet component, and a latch member, wherein the ratchet base is disposed on the flange, and the ratchet component is arranged with the latch member in the ratchet base;
a retaining ring, fastened in the groove and pressing against the ratchet base, wherein the ratchet base is clamped by the retaining ring to be positioned on the fixing end; and
a control set, movably disposed on the ratchet base, and comprising an operation key, and a pin and a spring assembled in the operation key, wherein the pin is combined with the spring to elastically abut against the latch member to make the latch member be engaged with the ratchet component.

2. The ratchet wrench assembly structure according to claim 1, further comprising a T-handle combined with the rod body, and wherein the ratchet set is accommodated in the T-handle.

3. The ratchet wrench assembly structure according to claim 2, further comprising a C-ring fastened on one end of the T-handle, wherein a notch is defined on the rod body and is located between the working end and the fixing end, and the T-handle is fixed on the rod body through the C-ring embedded in the notch.

4. The ratchet wrench assembly structure according to claim 2, further comprising a cover plate combined with the T-handle, wherein a sliding groove is defined on the T-handle, and an opening is defined between the cover plate and the T-handle, the sliding groove is exposed from the cover plate, and one end of the operation key protrudes from the opening and is exposed on the sliding groove.

5. The ratchet wrench assembly structure according to claim 4, wherein the T-handle comprises an accommodating space, the accommodating space comprises a first cavity and a second cavity communicating with each other, a bottom plate is disposed in the first cavity, the ratchet base is accommodated in the first cavity, the sliding groove is located in the second cavity, and the cover plate is accommodated in the second cavity.

6. The ratchet wrench assembly structure according to claim 4, wherein a hole is defined on the ratchet set, the operation key comprises a key part and a lever part, the key part extends into the hole to abut against the ratchet component, and the lever part rotates left and right along the sliding groove under an external force.

7. The ratchet wrench assembly structure according to claim 6, wherein a receiving hole is defined on the key part, and the spring is adapted to sheathe the pin and inserted in the receiving hole.

8. The ratchet wrench assembly structure according to claim 7, wherein the pin comprises a head and a shaft, the spring is adapted to sheathe the shaft, one end of the spring abuts against the head, and another end of the spring presses against a wall of the receiving hole.

9. The ratchet wrench assembly structure according to claim 4, wherein a plurality of first teeth is disposed equidistantly on an outer periphery of the ratchet component, the latch member comprises a plurality of second teeth arranged continuously on a side facing the ratchet component, the latch member is pushed by the pin to make the second teeth be engaged with the first teeth.

10. The ratchet wrench assembly structure according to claim 1, further comprising a sleeve with a plurality of anti-slip ribs, wherein the sleeve is adapted to sheathe the working end.
